(19) United States
(12) Patent Application Publication
(10) Pub. No.: US 2026/0100149 A1
(43) Pub. Date: Apr. 9, 2026

(54) IMAGE DISPLAY METHOD AND APPARATUS, AND ELECTRONIC DEVICE

(71) Applicant: Goertek Inc., Weifang, Shandong (CN)

(72) Inventor: Gaojian Shi, Shandong (CN)

(73) Assignee: Goertek Inc., Weifang, Shandong (CN)

(21) Appl. No.: 19/113,573

(22) PCT Filed: Aug. 8, 2023
(86) PCT No.: PCT/CN2023/111794

§ 371 Date: Mar. 20, 2025

(30) Foreign Application Priority Data
Sep. 29, 2022 (CN) 202211204498.4

(51) Int. Cl. G09G 3/00; G06F 3/14

(52) U.S. Cl. CPC G09G 3/001; G06F 3/1446; G09G 2340/02; G09G 2340/0464; G09G 2352/00; G09G 2370/16

(57) ABSTRACT

The disclosure discloses an image display method and apparatus as well as an electronic device. The method includes: receiving first data corresponding to a first region of an image; processing the first data; displaying the first region of the image, and concurrently receiving second data and processing the second data corresponding to a second region of the image.

### CROSS-REFERENCE TO RELATED APPLICATIONS

The present disclosure is a National Stage of International Application No. PCT/CN2023/111794, filed on Aug. 8, 2023, which claims priority to a Chinese patent application No. 202211204498.4 filed with the CNIPA on Sep. 29, 2022 and entitled “IMAGE DISPLAY METHOD AND APPARATUS, AND ELECTRONIC DEVICE”, both of which are hereby incorporated by reference in their entireties.

### TECHNICAL FIELD

The present disclosure relates to the technical field of displaying an image, and particularly to an image display method and apparatus, and an electronic device.

### BACKGROUND

In a wireless streaming scenario, image data is transmitted from a terminal device to a head mounted device for viewing. Typically, the terminal device encodes the image and transmits the encoded data to the head mounted device, which then decodes and displays the image.

During the process of displaying an image on the screen, it is typically done in blocks. For example, the upper half of the image is displayed first, followed by the lower half. While displaying the upper half of the image, only the data corresponding to the upper half is utilized. However, during the encoding and decoding processes of the image, the lower half is also processed. The data corresponding to the lower half does not contribute to the display of the upper half and instead adds delay to the image display process.

### SUMMARY

An objective of the present disclosure is directed to provide a new image display method and apparatus as well as electronic device, which can reduce the delay in the process of displaying the image.

According to a first aspect of the present disclosure, an image display method is provided, which includes:

receiving first data corresponding to a first region of an image;

processing the first data;

displaying the first region of the image; and

during the “displaying the first region of the image”, receiving second data and processing the second data, wherein the second data corresponds to a second region of the image.

Optionally, the second data is a conversion in form and/or format from the second region of the image during the processing of the first data.

Optionally, the method is applied to a display subject, and the “displaying the first region of the image” includes:

displaying the first region of the image at a position on the display subject corresponding to the first region of the image;

after the “displaying the first region of the image”, the method further includes:

displaying the second region of the image at a position on the display subject corresponding to the second region of the image.

Optionally, the method is applied to a first display subject and a second display subject, the first region includes a first part and a second part, and the first data includes data of the first part and the second part;

the “displaying the first region of the image” includes:

displaying the first part of the image at a position on the first display subject corresponding to the first part; and

displaying the second part of the image at a position on the second display subject corresponding to the second part.

Optionally, the second region includes a third part and a fourth part,

displaying the third part of the image at a position on the first display subject corresponding to the third part; and

displaying the fourth part of the image at a position on the second display subject corresponding to the fourth part.

Optionally, the “processing the first data” includes:

processing data corresponding to the first part; and

during the “processing data corresponding to the first part”, processing data corresponding to the second part.

According to a second aspect of the present disclosure, an image display apparatus is provided, which includes:

a first receiving module configured for receiving first data corresponding to a first region of the image;

a first processing module configured for processing the first data;

a first display module configured for displaying the first region of the image;

a second receiving module configured for receiving second data during the “displaying the first region of the image”; and

a second processing module configured for processing the second data.

Optionally, the apparatus is applied to a display subject;

the first display module is further configured for displaying the first region of the image at a position on the display subject corresponding to the first region of the image; and

the second display module is further configured for displaying the second region of the image at a position on the display subject corresponding to the second region of the image.

Optionally, the apparatus is applied to a first display subject and a second display subject, the first region includes a first part and a second part, and the first data includes data of the first part and the second part;

the first display module is further configured for displaying the first part of the image at a position on the first display subject corresponding to the first part; and

the second display module is further configured for displaying the second part of the image at a position on the second display subject corresponding to the second part.

According to a third aspect of the present disclosure, an electronic device is provided, which includes a processor and a memory, the memory stores a program or instruction that is executable by the processor, and the program or instruction, when executed by the processor, implements steps of the image display method according to the first aspect of the present disclosure.

According to embodiments of the present disclosure, by processing different regions of the image separately for encoding and decoding, it is not necessary to fully encode the entire image before sending it. While displaying the first region of the image, the second region of the image can be decoded concurrently, which reduces the delay in the process of displaying the image.

Other features and advantages of the present disclosure will become apparent from the following detailed description of exemplary embodiments of the present disclosure with reference to the accompanying drawings.

### BRIEF DESCRIPTION OF THE DRAWINGS

In order to clearly illustrate embodiments of the present disclosure or technical solutions in the prior art, accompanying drawings that need to be used in description of the embodiments or the prior art will be briefly introduced as follows. It is evident that drawings in following description are only the embodiments of the present disclosure. For those skilled in the art, other drawings can also be obtained according to the disclosed drawings without creative efforts.

FIG. 1 is a flowchart of an image display method in an embodiment of the present disclosure.

FIG. 2 is a schematic diagram of a wireless streaming scenario in embodiments of the present disclosure.

FIG. 3 is a schematic diagram of a chunked-encoding image display in an embodiment of the present disclosure.

FIG. 4 is a schematic diagram of an image display apparatus in an embodiment of the present disclosure.

FIG. 5 is a schematic diagram of an electronic device in an embodiment of the present disclosure.

### DETAILED DESCRIPTION

Technical solutions in the embodiments of the present disclosure are described below with reference to the accompanying drawings in the embodiments of the present disclosure. Apparently, the described embodiments are merely some rather than all of the embodiments of the present disclosure. All other embodiments, acquired by those of ordinary skill in the art based on the embodiments of the present disclosure without any creative work, should fall into the protection scope of the present disclosure.

Various exemplary embodiments of the present disclosure will now be described in detail with reference to the accompanying drawings. It is to be noted that unless otherwise specified, the relative arrangements, numerical expressions and values of components and steps illustrated in the embodiments do not limit the scope of the present disclosure.

The description of at least one exemplary embodiment is for illustrative purpose only and in no way implies any restriction on the present disclosure, its application, or use.

Techniques, methods and devices known to those skilled in the prior art may not be discussed in detail; however, such techniques, methods and devices shall be regarded as part of the description where appropriate.

In all the examples illustrated and discussed herein, any specific value shall be interpreted as illustrative rather than restrictive. Therefore, other examples of the exemplary embodiments may have different values.

It is to be noted that similar reference numbers and alphabetical letters represent similar items in the accompanying drawings. Once an item is defined in one drawing, further reference to it may be omitted in subsequent drawings.

The embodiments of the present disclosure introduce an image display method for use with a head mounted device. The head mounted device may be a device with display capabilities, capable of displaying images, videos, etc. For example, the head mounted device may be AR (Augmented Reality) glasses. The image display method in the present disclosure is intended for use in the wireless streaming scenarios.

In a wireless streaming scenario, the head mounted device receives image data sent from other devices, which may be devices such as virtual terminals, cloud servers, or mobile devices. This other device encodes the image data and sends the encoded data to the head mounted device. The head mounted device decodes the encoded data before displaying it. In the wireless streaming scenario as shown in FIG. 2, communication between AR glasses and a smartphone can be carried out via WIFI. After encoding the image data, the smartphone sends the encoded data to the AR glasses, which decode the encoded data and display the image data.

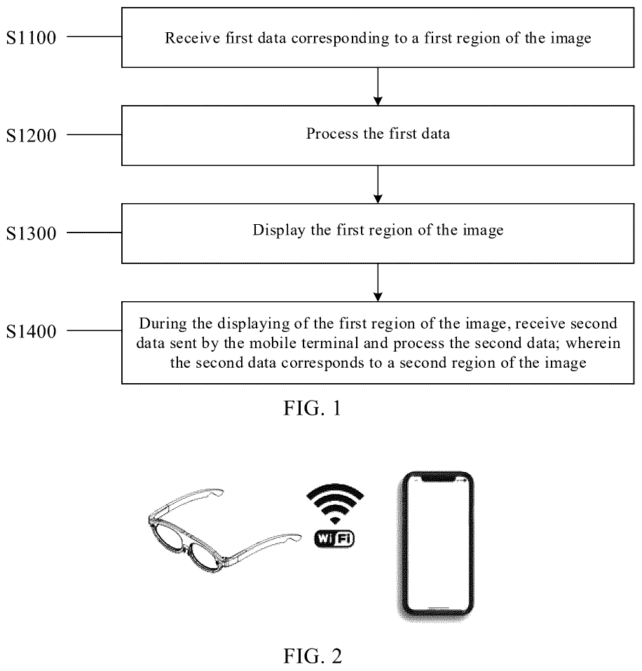

As shown in FIG. 1, the image display method includes steps S1100-S1400.

S1100: receiving first data corresponding to a first region of the image.

The first region is a portion of the image, and the first data is data obtained by processing the first region of the image by other device. For example, the first region is the upper half of the image, the other device encodes the upper half of the image, and the first data is the encoded data corresponding to the upper half of the image.

The other device sends the first data to the head mounted device, and the head mounted device receives the first data sent from the other device. For example, the head mounted device is AR glasses, the other device is a smartphone, and after encoding the upper half of the image by the smartphone, the encoded data corresponding to the upper half of the image is obtained, and the AR glasses receives the encoded data corresponding to the upper half of the image sent from the smartphone.

S1200: processing the first data.

After receiving the first data, the head mounted device processes the first data. For example, the first data received by the head mounted device is encoded data, then the head mounted device will decode it.

S1300: displaying the first region of the image.

Displaying the first region of the image on the screen of the head mounted device. The position where the first region is displayed on the screen corresponds to its position in the image. If the first region is the upper half of the image, it is displayed in the upper half of the screen.

S1400: during the “displaying the first region of the image”, receiving second data and processing the second data, wherein the second data corresponds to a second region of the image.

The second region may be a different region of the image from the first region. If the first region is the upper half of the image, the second region could be the lower half of the image. The second data is the data obtained by processing the second region of the image by another device. For example, the other device may encode the lower half of the image, and the second data is the encoded data corresponding to the second region of the image.

In one implementation, the second data is a conversion in form and/or format from the second region of the image during processing of the first data.

During displaying the first region of the image by the head mounted device, the head mounted device receives the second data and processes it. The processing method for the second data can be the same as that for the first data. For example, the first data is encoded data corresponding to the upper half of the image and the second data is encoded data corresponding to the lower half of the image, then both the first data and the second data are decoded.

In an example, the image is divided into an upper half and a lower half. The smartphone encodes the upper half of the image, and starts transmitting the encoded data corresponding to the upper half of the image to the AR glasses. During the transmission of the encoded data corresponding to the upper half of the image, the smartphone encodes the lower half of the image. After the AR glasses receive the encoded data corresponding to the upper half of the image, the AR glasses decode the encoded data corresponding to the upper half of the image and display the upper half of the image. During displaying of the upper half of the image by the AR glasses, the AR glasses receive the encoded data corresponding to the lower half of the image and decode it. Once the upper half of the image has been fully displayed, the AR glasses display the lower half of the image.

The present embodiment divides the image into parts for encoding and decoding, eliminating the need to fully encode the entire image before sending it. By decoding the second region of the image in parallel while displaying the first region of the image, it is possible to reduce the delay in the process of displaying the image.

In one implementation, the method is applied to a display subject, and the step S1300 includes: displaying the first region of the image at a position on the display subject corresponding to the first region of the image. After the step S1300, the method further includes: displaying the second region of the image at a position on the display subject corresponding to the second region of the image.

The display subject can be the screen of the head mounted device. Based on the position of the first region in the image, it is possible to obtain the position corresponding to the first region on the display subject. For example, if the first region is the upper half of the image, the position corresponding to the first region on the display subject is also the upper half of the display subject, and the first region is displayed in the upper half of the display subject when displaying the first region.

Once the first region has been fully displayed, the second region is displayed next. Based on the position of the second region in the image, it is possible to obtain the position corresponding to the second region on the display subject. For example, if the second region is the lower half of the image, the position corresponding to the second region on the display subject is also the lower half of the display subject, and the second region is displayed in the lower half of the display subject when displaying the second region.

In one example, the AR glasses receive encoded data corresponding to the upper half of the image sent from the smartphone, and display the upper half of the image in the upper half of the screen of the AR glasses after decoding the encoded data corresponding to the upper half of the image. During the AR glasses displaying the upper half of the image, it decodes the encoded data corresponding to the lower half of the image. Once the upper half of the image has been fully displayed, the lower half of the image is displayed in the lower half of the screen of the AR glasses.

In one implementation, in the case where the method is applied to a first display subject and a second display subject, the first region includes a first part and a second part, and the first data includes data of the first part and the second part. The step S1300 includes: displaying the first part of the image at a position on the first display subject corresponding to the first part; and displaying the second part of the image at a position on the second display subject corresponding to the second part.

The head mounted device has a first display subject and a second display subject, both of which can be used to display the image. Different regions of the image can be displayed through the first display subject and the second display subject.

For the first region of the image, the first region of the image is divided into a first part and a second part. For example, the first region can be divided into the first part and the second part along the width direction of the image. The height of the first part and the height of the second part are both equal to the height of the first region, while the width of the first part and the width of the second part are both half the width of the first region.

During encoding the first region of the image, the first part and the second part can be encoded in parallel. For example, a first encoder and a second encoder can be provided on the smartphone. The first encoder encodes the first part to obtain the encoded data corresponding to the first part. While the first part is being encoded, the second encoder encodes the second part to obtain the encoded data corresponding to the second part.

When displaying the first region of the image, the first part is displayed through the first display subject, and the second part is displayed through the second display subject. Based on the position of the first region in the image, it is possible to obtain the position corresponding to the first part on the first display subject and the position corresponding to the second part on the second display subject. For example, if the first region is the upper half of the image, then the position corresponding to the first part on the first display subject is the upper half of the first display subject, and the position corresponding to the second part on the second display subject is the upper half of the second display subject.

In the case where the method is applied to both the first display subject and the second display subject, the second region includes a third part and a fourth part. After displaying the first region of the image, the third part of the image is displayed at a position on the first display subject corresponding to the third part, and the fourth part of the image is displayed at a position on the second display subject corresponding to the fourth part.

For the second region of the image, the second region is divided into a third part and a fourth part. For example, the second region can be divided into the third part and the fourth part along the width direction of the image. The height of the third part and the height of the fourth part are both equal to the height of the second region, while the width of the third part and the width of the fourth part are both half the width of the second region.

When displaying the second region of the image, the third part is displayed through the first display subject, and the fourth part is displayed through the second display subject. Based on the position of the second region in the image, it is possible to obtain the position corresponding to the third part on the first display subject and the position corresponding to the fourth part on the second display subject. For example, if the second region is the lower half of the image, then the position corresponding to the third part on the first display subject is the lower half of the first display subject, and the position corresponding to the fourth part on the second display subject is the lower half of the second display subject.

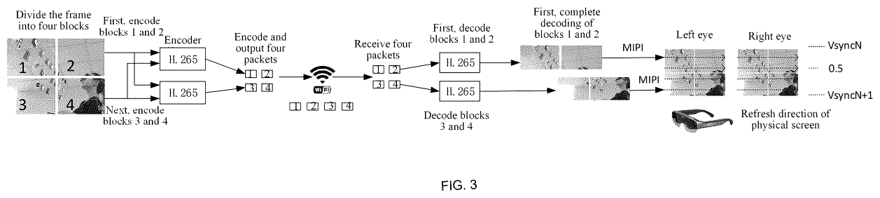

As shown in FIG. 3, the image frame is divided into four blocks. The first and second blocks of the image frame constitute the upper half of the image frame, while the third and fourth blocks constitute the lower half of the image frame. Inside the smartphone, two encoders are provided to simultaneously encode the first and second blocks of the image frame. The encoded data corresponding to the first and second blocks of the image frame is transmitted to the AR glasses via WIFI. The AR glasses use two decoders to simultaneously decode the encoded data corresponding to the first and second blocks of the image frame. After decoding, the first block of the image frame is displayed in the upper half of the left screen of the AR glasses, and the second block of the image frame is displayed in the upper half of the right screen of the AR glasses. While displaying the first and second blocks of the image frame, the AR glasses decode the encoded data corresponding to the third and fourth blocks of the image frame. Once the first and second blocks of the image frame have been fully displayed, the third block of the image frame is displayed in the lower half of the left screen of the AR glasses, and the fourth block of the image frame is displayed in the lower half of the right screen of the AR glasses.

In one implementation, processing the first data includes: processing the data corresponding to the first part; and, during the “processing data corresponding to the first part”, processing data corresponding to the second part.

The first data includes data of the first part and data of the second part. After receiving the first data, the head mounted device processes the first data, and can process the data of the first part and the data of the second part in parallel. While processing the data of the first part, the head mounted device simultaneously processes the data of the second part. For example, the head mounted device is provided with a first decoder and a second decoder. The first decoder decodes the data of the first part. During decoding the data of the first part, the second decoder decodes the data of the second part.

In the present embodiment, by processing the data corresponding to the second part while processing the data corresponding to the first part, the processing time for the first data is reduced, thereby reducing the delay in the process of displaying the images.

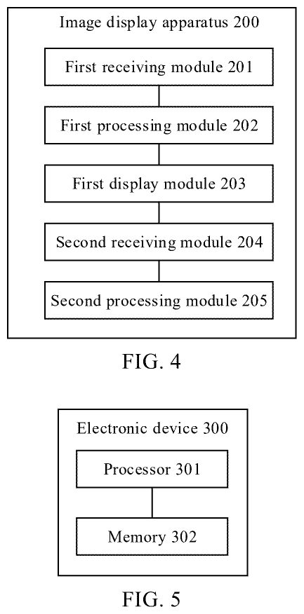

As shown in FIG. 4, an embodiment of the present disclosure introduces an image display apparatus 200, which includes:

a first receiving module 201 configured for receiving first data corresponding to the first region of the image;

a first processing module 202 configured for processing the first data;

a first display module 203 configured for displaying the first region of the image;

a second receiving module 204 configured for receiving second data during the “displaying the first region of the image”;

a second processing module 205 configured for processing the second data.

In one implementation, the second data is a conversion in form and/or format from the second region of the image during processing of the first data.

In one implementation, the apparatus is applied to a display subject. The first display module is further configured for displaying the first region of the image at a position on the display subject corresponding to the first region of the image.

The second display module is further configured for displaying the second region of the image at a position on the display subject corresponding to the second region of the image.

In one implementation, the apparatus is applied to a first display subject and a second display subject. The first region includes a first part and a second part, and the first data includes data of the first part and data of the second part.

The first display module is further configured for displaying the first part of the image at a position on the first display subject corresponding to the first part.

The second display module is further configured for displaying the second part of the image at a position on the second display subject corresponding to the second part.

In one implementation, the first processing module is further configured for processing the data corresponding to the first part and, during processing the data corresponding to the first part, processing the data corresponding to the second part.

As shown in FIG. 5, an embodiment of the present disclosure introduces an electronic device 300, which includes a processor 301 and a memory 302. The memory 302 stores a program or instruction that is executable by the processor 301. The program or instruction, when executed by the processor 301, implements the steps of the image display method according to any embodiment of the present disclosure.

The present disclosure may also include a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, comprising an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, comprising a local area network (LAN) or a wide area network (WAN), or the connection may be made to an external computer (for example, through the Internet using an Internet Service Provider). In some embodiments, electronic circuitry comprising, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, computing devices, and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture comprising instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of computing devices, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. It is well-known to a person skilled in the art that the implementations of using hardware, using software or using the combination of software and hardware can be equivalent.

Embodiments of the present disclosure have been presented for purposes of illustration, but are not intended to be exhaustive or limited to the embodiments disclosed. Numerous modifications and changes will be apparent to those skilled in the art without departing from the scope and spirit of the illustrated embodiments. The terminology used herein was chosen to best explain the principles of the embodiments, the practical application or technical improvement over technologies found in the marketplace, or to enable others of ordinary skill in the art to understand the embodiments disclosed herein.

The various embodiments in the present specification are described in a side-by-side or progressive manner, and each embodiment focuses on the differences with other embodiments, and the same or similar parts between the various embodiments can be seen in each other. For the device disclosed in the present embodiment, since it corresponds to the method disclosed in the embodiment, the description is relatively simple, and the relevant points can be found in the method section.

It will also be understood by those of ordinary skill in the art that the units and algorithmic steps of the various examples described in connection with the embodiments disclosed herein are capable of being realized in electronic hardware, computer software, or a combination of the two, and in order to clearly illustrate the interchangeability of the hardware and the software, the compositions and the steps of the various examples have been described in the foregoing description in general terms according to the functions. Whether these functions are performed in hardware or software depends on the particular application and design constraints of the technical solution. The skilled professional may use different methods to implement the described functions for each particular application, but such implementations should not be considered outside the scope of the present disclosure.

It should also be noted that in this document, relational terms such as first and second are used only to distinguish one entity or operation from another, and do not necessarily require or imply any such actual relationship or order between these entities or operations. Furthermore, the terms “including”, “comprising”, or any other variant thereof, are intended to cover non-exclusive inclusion, such that a process, method, article or device comprising a set of elements includes not only those elements, but also other elements that are not explicitly listed or that are inherent to such process, method, article or device. Without further limitation, the fact that an element is defined by the statement “includes a.” does not preclude the existence of additional identical elements in the process, method, article or apparatus that includes the said element.

1. An image display method, comprising:
receiving first data corresponding to a first region of an image;
processing the first data; and
displaying the first region of the image, and
concurrently with the displaying the first region of the image, receiving second data corresponding to a second region of the image and processing the second data.

2. The method according to claim 1, wherein the second data comprises a conversion in form and/or format from the second region of the image during the processing of the first data.

3. The method according to claim 1, wherein the method is applied to a display subject, and the displaying the first region of the image comprises:
displaying the first region of the image at a position on the display subject corresponding to the first region of the image; and
after the displaying the first region of the image, the method further comprises:
displaying the second region of the image at a position on the display subject corresponding to the second region of the image.

4. The method according to claim 1, wherein the method is applied to a first display subject and a second display subject, the first region comprises a first part and a second part, and the first data comprises data of the first part and the second part;
the displaying the first region of the image comprises:
displaying the first part of the image at a position on the first display subject corresponding to the first part; and
displaying the second part of the image at a position on the second display subject corresponding to the second part.

5. The method according to claim 4, wherein the second region comprises a third part and a fourth part, and after the displaying the first region of the image, the method further comprises:
displaying the third part of the image at a position on the first display subject corresponding to the third part; and
displaying the fourth part of the image at a position on the second display subject corresponding to the fourth part.

6. The method according to claim 1, wherein the processing the first data comprises:
processing data corresponding to the first part, and concurrently processing data corresponding to the second part.

7. An image display apparatus, comprising:
a first receiving module configured for receiving first data corresponding to a first region of an image;
a first processing module configured for processing the first data;
a first display module configured for displaying the first region of the image;
a second receiving module configured for receiving second data, concurrently with displaying the first region of the image through the first display module; and
a second processing module configured for processing the second data.

8. The apparatus according to claim 7, wherein the apparatus is adapted to a display subject;
the first display module is further configured for displaying the first region of the image at a position on the display subject corresponding to the first region of the image; and
the second display module is further configured for displaying the second region of the image at a position on the display subject corresponding to the second region of the image.

9. The apparatus according to claim 7, wherein the apparatus is adapted to a first display subject and a second display subject, the first region comprises a first part and a second part, and the first data comprises data of the first part and the second part;
the first display module is further configured for displaying the first part of the image at a position on the first display subject corresponding to the first part; and
the second display module is further configured for displaying the second part of the image at a position on the second display subject corresponding to the second part.

10. An electronic device, comprising,
a processor, and
a memory, communicatively coupled to the processor,
wherein the memory store a program or instruction that, when executed by the processor, implement the image display method according to claim 1.
